(19) United States
(12) Patent Application Publication
(10) Pub. No.: US 2015/0226537 A1
(43) Pub. Date: Aug. 13, 2015

(54) SYSTEM AND METHOD FOR OPTICAL COHERENCE TOMOGRAPHY AND POSITIONING ELEMENT

(71) Applicant: Agfa HealthCare NV, Mortsel (BE)

(72) Inventors: Wolfgang Schorre, Wolfratshausen (DE); Rainer Nebosis, Munich (DE)

(21) Appl. No.: 14/424,479

(22) PCT Filed: Aug. 14, 2013
(86) PCT No.: PCT/EP2013/002439

§ 371 Date: Feb. 27, 2015

(30) Foreign Application Priority Data
Aug. 29, 2012 (EP) 12006124.7

(51) Int. Cl. G01B 9/02

(52) U.S. Cl. CPC G01B 9/0205; G01B 9/02089; G01B 9/0203; G01B 9/02091

(57) ABSTRACT

A system and method for optical coherence tomography includes an interferometer and a sensor head which emits electromagnetic radiation toward an object to be examined and electromagnetic radiation reflected by the object is fed back into the interferometer; a positioning element configured to position the sensor head relative to the object to be examined and including a support which is provided at the object and on which the sensor head can be placed, a first area that is substantially transmissive to the radiation emitted by the interferometer and reflected by the object, and a second area having a transmittance to the radiation emitted by the interferometer and/or reflected by the object that is different from the transmittance of the first area; an image generator configured to generate one or more images on the basis of the electromagnetic radiation reflected by the object and/or by the positioning element; a display device configured to display the generated images; and a controller configured to control the generation and display of the images in such a manner that the sensor head can be brought into a desired position on the positioning element on the basis of the generated and displayed images.

### CROSS-REFERENCE TO RELATED APPLICATIONS

This application is a 371 National Stage Application of PCT/EP2013/002439, filed Aug. 14, 2013. This application claims the benefit of European Application No. 12006124.7, filed Aug. 29, 2012, which is incorporated by reference herein in its entirety.

### BACKGROUND OF THE INVENTION

1. Field of the Invention

The present invention relates to a system and method for optical coherence tomography as well as a positioning element for positioning a sensor head relative to an object to be examined.

2. Description of the Related Art

Optical coherence tomography (OCT) is a method of measuring light-scattering specimens on their inside. Due to its light-scattering properties biological tissue is particularly suitable for diagnostic examination by OCT. Since for OCT relatively low light intensities are sufficient and the wavelengths of the light used mostly come within the near infrared range (750 nm to 1350 nm), unlike ionising X-ray diagnostics it does not contaminate biological tissue with radiation. It is therefore particularly significant for medicine and is roughly comparable to ultrasound diagnostics, wherein with OCT, light is used instead of sound. The running times of the light reflected on different boundary layers within the specimen are recorded with the aid of an interferometer. With OCT, typically resolutions higher by one to two orders of magnitude are to be achieved than with ultrasound, but the measuring depth achievable is considerably smaller. Due to optical scattering the cross-section images obtained usually only reach into the tissue up to a depth of a few millimeters. The currently most important regions of application of OCT are in ophthalmology, dermatology and the diagnosis of cancer. However, there are also some non-medical applications, such as e.g. in materials testing.

### SUMMARY OF THE INVENTION

In medical applications, a precise positioning of the sensor head of an OCT system relative to the object to be examined is highly relevant for the reliability of the diagnostic information acquired during an examination. At the same time, the handling must be configured in a way that is as simple and time-saving as possible.

The problem addressed by the present invention is to provide a system and a method for optical coherence tomography as well as a positioning element for use in such a system and method respectively, which facilitates a reliable and time-saving examination of an object with the most straightforward handling possible.

The above advantages and benefits are achieved by, respectively, the system, the method and the positioning element described below.

The inventive system for optical coherence tomography comprises:
an interferometer and a sensor head, by which electromagnetic radiation can be emitted from the interferometer toward an object to be examined and electromagnetic radiation reflected by the object can be fed back into the interferometer,
a positioning element for positioning the sensor head relative to the object to be examined, comprising a support which is arranged at the object and on which the sensor head can be placed, and a first area, which is substantially transmissive to the radiation emitted by the interferometer and reflected by the object, and a second area, of which the transmittance to the radiation emitted by the interferometer and/or reflected by the object is different from the transmittance of the first area,
an imaging device for generating one or more images on the basis of the electromagnetic radiation reflected by the object and/or by the positioning element, in particular by the second area of the positioning element,
a display device for displaying the generated images and
a control device for controlling the generation and display of the images in such a manner that the sensor head can be brought into a desired position on the positioning element on the basis of the generated and displayed images.

In the inventive method for optical coherence tomography:
electromagnetic radiation is emitted by an interferometer toward an object to be examined via a sensor head and electromagnetic radiation reflected by the object is fed back into the interferometer via the sensor head,
a positioning element for positioning the sensor head is provided relative to the object to be examined and the sensor head is placed on the support, said support comprising a first area, which is substantially transmissive to the radiation emitted by the interferometer and reflected by the object, and a second area, of which the transmittance to the radiation emitted by the interferometer and/or reflected by the object is different from the transmittance of the first area,
one or more images are generated and displayed on the basis of the electromagnetic radiation reflected by the object and/or by the positioning element, in particular by the second area of the positioning element, and
the sensor head is brought into a desired position on the positioning element on the basis of the generated and displayed images.

The inventive positioning element for use in a system for optical coherence tomography, said system comprising an interferometer and a sensor head, through which electromagnetic radiation can be emitted by the interferometer toward an object to be examined and electromagnetic radiation reflected by the object can be fed back into the interferometer, wherein the positioning element:
allows for positioning the sensor head relative to an object to be examined and
comprises a support, which can be provided at the object and on which the sensor head can be placed, said support comprising a first area, which is substantially transmissive to the radiation emitted by an interferometer and radiation reflected by the object, and a second area, of which the transmittance to the radiation emitted by the interferometer and/or the radiation reflected by the object is different from the transmittance of the first area.

A preferred embodiment of the invention is based on the thought of using a positioning element for positioning an OCT sensor head relative to the object to be examined, said positioning element comprising at least two areas having different optical properties, in particular a different transmittance and/or reflexivity for the electromagnetic radiation emitted by the interferometer and/or reflected by the object. The positioning element is thereby provided at the object in such a manner that the area to be examined of the object, for example a skin lesion, is located in a first area of the positioning element, which is substantially transmissive to the radiation emitted by the interferometer and/or the radiation reflected by the object. Due to the different optical properties of both areas of the positioning element, a transition area between the first area and the second area can be distinguished in the acquired and displayed OCT images, if the sensor head has been placed on the positioning element in such a manner that the passage window of the sensor head positions itself in the transition area between the first and second area. When distinguishing such a transition area in the displayed OCT images, an operator may decide to modify the position of the sensor head relative to the current position, for example in order to position the passage window as central as possible relative to the first area, and to ensure in this way that, on the one hand, OCT images from the area to be examined of the object are precisely recorded and, on the other, that the respective displayed area of the sample has an optimal size. The OCT images generated and displayed in this way are, in particular, real time images, which allow an operator to perform a positioning, including a possible change of the sensor head's position if required, in a reliable and particularly comfortable way.

Overall, preferred embodiments of the invention allow for a precise positioning of the sensor head of an OCT system relative to the object to be examined, while ensuring straightforward and time-saving handling.

Preferably, the second area is substantially opaque to the radiation emitted by the interferometer and/or reflected by the object. As a result, a transition area between the first area, which is substantially transmissive to the radiation emitted by the interferometer and/or reflected by the object, becomes particularly clearly visible in the corresponding OCT images, thus allowing for a particularly precise positioning.

As an alternative or in addition, the second area has a structure whose optical properties are different from the optical properties of structures of the object. If the OCT system is used to record, for example, OCT images of the human skin organ, then a positioning element is selected the second area of which has a structure which, in the respective OCT images, are quite clearly different from the typical structures of the skin organ which one would expect. Preferably, the structure has a second area, in particular repetitive structural elements, which can be reliably resolved by the OCT system and which have, in particular, a lateral extent of approximately at least 3 μm. In the respective OCT images, such a structure of the second area can be distinguished with high reliability from the first area through which the area to be examined is imaged, thus allowing for a positioning which is also particularly secure and simple to perform by the operator.

In a further particularly preferred embodiment, the support of the positioning element has a flexible design, which allows the support to adapt itself, in particular, to contours of the object. This allows the positioning element to be easily provided also at curved locations of the object to be examined, thus providing assurance that the first area of the positioning element positions itself reliably on the area to be examined of the object and remains in this position both during the positioning of the sensor head and during the actual recording of OCT images for diagnostic purposes. The above design too ensures a precise positioning of the sensor head relative to the object to be examined, with straightforward handling.

Preferably, the support of the positioning element is designed in such a way that it can be brought into contact with the object and, in particular, be attached to the object. In particular, the support can be releasably attached to the object. Preferably, the support's underside facing the object is provided with at least one adhering area, which, when contacting the object, creates a releasable adhering connection with the latter. For example, the adhering area comprises a layer made of a pressure sensitive adhesive, which can be realized, for example, by applying a pressure sensitive adhesive directly onto the underside of the support or by applying a section of a double-sided adhesive tape onto the underside of the support. Preferably, the adhering area, in particular the layer made of a pressure sensitive adhesive, is provided with an additional protective layer, which is removed right before using the positioning element. A particularly suitable protective layer is, for example, waxed or siliconized protective paper. Preferably, only a partial area of the underside of the support, in particular in the vicinity of the first area, is provided with an adhering area.

Due to the fact that the object and the releasable attachment of the positioning element to the object enter into contact with one another, the positioning of the sensor head relative to the object, in particular to the area to be examined of the object, can be performed in a particularly reliable way, since, if it is required to modify the position of the sensor head during the positioning process, any slippage of the positioning element can be prevented in a simple and reliable way. Furthermore, this also ensures that the positioning element remains with high reliability above the area to be examined of the object during the actual recording of OCT images for diagnostic purposes, thus ensuring a precise recording of OCT images of the originally selected area of the object.

It is furthermore preferred that the first area of the support has the form of an aperture made in the support. Thanks to this design, the inventive difference of the optical properties of the first and second area can be achieved in a particularly straightforward way and at the same a particularly reliable positioning of the sensor head can be obtained.

In a further preferred embodiment, the form and/or size of the first area of the support is adapted to, respectively, the form and size of a passage area of the sensor head, through which the radiation emitted by the interferometer and the radiation reflected by the object can pass. If the sensor head has, for example, a passage area in the form of a substantially circular window having a diameter of approximately 2.5 mm, the first area also has a substantially circular form having a diameter of approximately 2.5 mm. The same applies to rectangular forms and other forms of the passage area, for example also to rectangular, in particular square, basic forms with rounded corners. This allows to achieve, on the one hand, a precise positioning of the sensor head relative to the object and, on the other, the recording of OCT images of a maximum cut from the object.

Preferably, the positioning element is provided with one or more markings, which support positioning the sensor head relative to the positioning element, in particular relative to the first and/or second area of the support. The markings can be, for example, lines and and/or circles and/or circular sections. The markings allow a first rough positioning of the sensor head, prior to positioning it fully precisely relative to the object during the inventive positioning process on the basis of the displayed OCT images. The prepositioning of the sensor head allows for a further simplification and acceleration of the positioning process itself.

Preferably, the markings are designed in such a way that they correspond to outer outlines and/or forms of the sensor head. If the sensor head end facing the object has, for example, a circular support area in the center of which the passage area in the shape of a circular window is provided, the markings can have the form, for example, of two concentric circular or circle sector-shaped rings, the centers of which coincide with the center of, respectively, the support area and the circular window. The diameter of the inner ring of both rings preferably corresponds essentially to the outer diameter of the support area of the sensor head, whereas the outer ring has a slightly larger diameter than the inner ring. As the human eye already distinguishes minor deviations from a concentric positioning of the support area of the sensor head, the operator can perform a reliable prepositioning of the sensor head in a straightforward and reliable way by using the outer ring.

It is furthermore preferred that the transmittance of the second area of the support to the radiation emitted by the interferometer and the radiation reflected by the object is less than 10⁻⁴, in particular less than 10⁻⁶. As only a fraction of, respectively, less than 0.01% and less than 0.0001% of the radiation impinging on the second area can pass through the second area of the support, the second area in the recorded OCT images is clearly distinguishable compared to the first area, which is substantially transmissive to the radiation reflected by the object, so that the sensor head can be positioned precisely opposite the object in a highly precise and secure way.

It is particularly preferred that the second area of the support comprises a reflective layer, which reflects the radiation emitted by the interferometer. In particular the second area of the support, in particular the reflective layer, has a reflectance for the radiation emitted by the interferometer of at least 30%, in particular at least 50%. This has the effect that electromagnetic radiation which is emitted by the sensor head and impinges on the second area of the support of the positioning element is reflected for the most part and is fed back into the interferometer via the sensor head. The intensity values in the corresponding image area of the OCT images thereby obtained are correspondingly high compared to intensity values in image areas, in which the reflectance behavior of the object to be examined is reproduced. As a result, a transition area between the first and second area of the support in the OCT images can be distinguished with very high reliability, so that the positioning of the sensor head can be performed very precisely, while ensuring a straightforward handling.

Preferably, the imaging device is designed for generating images from planes, which run substantially perpendicular to the direction of the electromagnetic radiation impinging on, respectively, the object and the positioning element and/or which run parallel to the surface of the object to be examined. The images thereby obtained are also referred to as en-face images. Correspondingly, the display device is preferably designed for displaying the obtained en-face images. The obtained and rendered en-face images allow to position the sensor head particularly precisely in a desired position on the positioning element. Thanks to this, the sensor head can, for example, be positioned in such a way that the entire first area or the largest possible part of the first area of the positioning element is comprised or visible in the generated and rendered en-face images. This has the effect that the OCT images recorded from the object, i.e. en-face images as well as slice images in planes running perpendicular to the surface of the object, originate exactly from the part of the object which is defined by the first area of the positioning element and that the respective area of the object represented in the OCT images thereby always has an optimal size.

It is preferred that the system is designed in such a way that images from different depths of the object are generated and rendered by the radiation reflected at the different depths of the object, wherein a transition area between the object and the positioning element, in particular between the first and second area of the positioning element, can be distinguished in the images which are obtained from the different depths of the object and displayed. This has the particular advantage that the transition area between the first and second area in the OCT images which is used for positioning is not only clearly distinguishable if the system detects OCT images in a depth area in which the positioning element is also located, but can also be precisely distinguished in the OCT images if the respective obtained OCT images originate from a depth area within the object which is located below the positioning element. Thanks to this, the sensor head can still be positioned relative to the object if during a so-called depth scan in the course of the examination of the object it proves necessary to perform a repositioning or to adjust the position, without additional control measures being required.

This preferred embodiment is particularly advantageous for the positioning of the sensor head if the second area of the positioning element is substantially opaque to the radiation emitted by the interferometer and/or reflected by the object, so that the area of the object which is located below the second area of the positioning element is “shadowed” by the second area of the positioning element and appears as a “dark” area in the OCT images from different depths. Thanks to this, in the en-face images recorded in the different planes of the object and rendered, a transition area between the object and the positioning element can also be distinguished if the respective plane of the en-face image does not run through the positioning element, but through the object located below it. This allows to also position the sensor head in the actual measuring mode, in which OCT images are recorded from planes at different depths of the object, in particular en-face images. Thanks to this, if required, the position of the sensor head which has been selected prior to start the measuring mode can be corrected subsequently in measuring mode during the recording of OCT images at different depths.

Preferably, the system comprises a detector for detecting the radiation reflected by the object and/or by the positioning element and the radiation fed back into the interferometer, the control device for controlling the detector being designed in such a way that it is in saturation mode during the detection of the radiation reflected by the positioning element and the radiation fed back into the interferometer. Therefore a maximum possible contrast can be achieved between the OCT image areas corresponding to the first and second area of the support, so that the transition area between the first and second area can be distinguished with particularly high reliability. This particularly applies in the case where the image signals are demodulated prior to being displayed as OCT images, as a result of which only variable image signal waveforms can be distinguished in the OCT images, whereas the constant saturation signal solely appears as a black area in the OCT images.

Furthermore, it is particularly preferred that the imaging device is designed for generating images of, respectively, the object and the positioning element at a rate of more than one image per second, in particular more than five images per second, and/or the display device is designed for displaying images of, respectively, the object and the positioning element at a rate of more than one image per second, in particular more than five images per second. At these image generation and displaying rates, it can be considered a generation and display of OCT images in real time, so that an operator can determine, on the basis of real time OCT images—i.e. on the basis of a respective current OCT image—if the sensor head is in the desired position relative to the object and is located in particular on or above the first area of the support of the positioning element, or if its position has to be slightly adapted if required. The operator can verify the change in position of the sensor head immediately after the change in position on the basis of the OCT images which are subsequently recorded and displayed in real time.

In a particularly advantageous and preferred embodiment of the invention, the control device is designed for generating and displaying en-face images in real time, so that the sensor head can be brought into the desired position on the positioning element by using the en-face images which are recorded and displayed in real time. This allows bringing the sensor head into an optimal position relative to, respectively, the positioning element and the object in a quick, reliable and comfortable way, so that en-face images and/or slice images of optimal size are obtained from the part of the object which is defined by the first area of the positioning element.

The object to be examined is preferably biological tissue, in particular the skin organ of a human or an animal. Basically, the invention can however also be used for the examination of other human or animal organs.

Additional advantages, features and possible applications of the present invention are specified in the following description in the context of the figures. The drawings show:

### BRIEF DESCRIPTION OF THE DRAWINGS

FIG. 1 is a schematic representation of an example of a system for optical coherence tomography equipment.

FIG. 2 is a schematic representation of an example of a detector surface for illustrating a first operating mode.

FIG. 3 is a spatial element of the object with cuts in first planes for the illustration of the first operating mode.

FIG. 4 is a spatial element of the object with a cut in a second plane for the illustration of a second operating mode.

FIG. 5 is a spatial element of the object with cuts in second planes for the illustration of a third operating mode.

FIGS. 6a and 6b are two cross sections through the object and the sample arm of the interferometer for the illustration of the focus tracking.

FIG. 7 is an example of a regular grid for the illustration of the interpolation of initial image values.

FIG. 8 is a schematic view for illustrating a sampling of an interference pattern in the direction of the depth of an object in comparison to the physical resolution in the direction of the depth.

FIG. 9 is an additional schematic view for illustrating a compilation of original initial image values, sampled in the direction of the depth of an object, relative to respectively one initial image value in comparison to the physical resolution in the direction of the depth.

FIG. 10 is an additional schematic view for the illustration of the interpolation of the initial image values from two initial images obtained in the direction of the depth of the object.

FIG. 11 is an additional schematic view for the illustration of the recording of the initial image values in one (left) or two (right) planes that are transversal to the direction of the depth of an object, as well as the interpolation of the initial image values of the initial images obtained from the two planes (right).

FIG. 12 is an example of an initial image (left) in comparison with a corresponding final image (right) that was obtained by the described interpolation.

FIG. 13 is a further example of a system for optical coherence tomography.

FIG. 14 is a representation of a sensor head of the system.

FIG. 15 is a representation of the sensor head together with a positioning element.

FIG. 16 is a first example of a positioning element shown in top view on the side facing the sensor head (left) and the side facing the object (right).

FIG. 17 is a further example of a positioning element shown in top view on the side facing the sensor head (left) and the side facing the object (right).

FIG. 18 is a cross-sectional representation of the positioning process in different phases a) to c).

FIG. 19 is a first example for OCT images recorded using an opaque positioning element (a) slice image, b) en-face image).

FIG. 20 is a second example for OCT images recorded using an opaque positioning element (a) slice image, b) en-face image).

FIG. 21 is a first example for OCT images recorded using a highly reflective positioning element (a) slice image, b) en-face image).

FIG. 22 is a second example for OCT images recorded using a highly reflective positioning element (a) slice image, b) en-face image).

FIG. 23 is a third example for OCT images recorded using a highly reflective positioning element (a) slice image, b) en-face image).

### DETAILED DESCRIPTION OF THE PREFERRED EMBODIMENTS

### 1. Optical Coherence Tomography Equipment

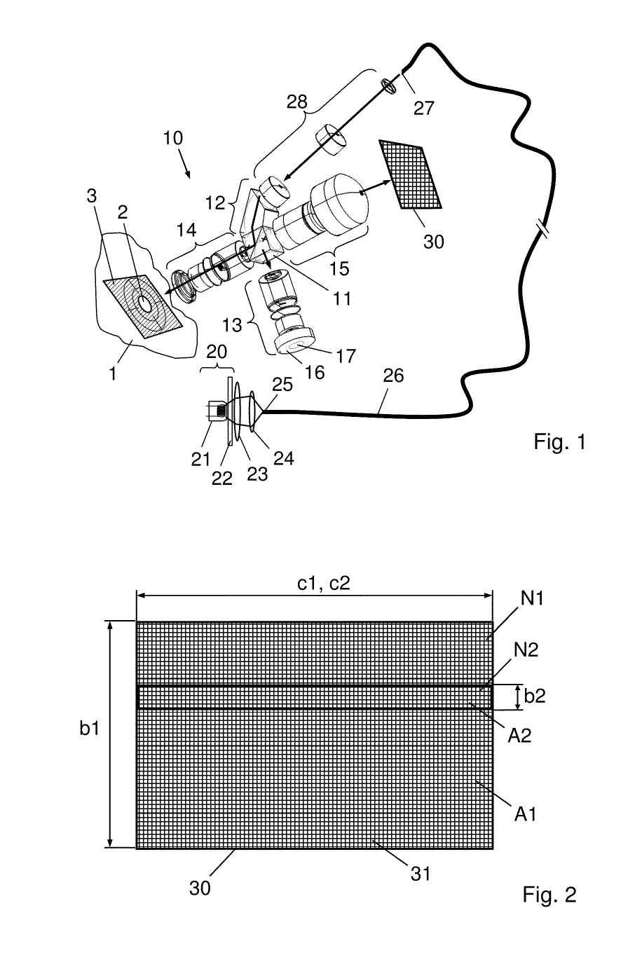

FIG. 1 shows a schematic representation of an example of a system for optical coherence tomography, which comprises an optical coherence tomography equipment, hereinafter also referred to as OCT equipment.

The OCT equipment comprises an interferometer 10, which comprises a beam splitter 11, an illumination arm 12, a reference arm 13, a sample arm 14 and a detector arm 15. In addition, a radiation source 21 is provided for generating light, which is filtered by an optical filter 22 and is focused through optics composed of lenses 23 and 24 onto an input area 25 of an optical waveguide 26. The radiation source 21, together with the optical filter 22, forms a device which is also designated as light source 20.

The light injected into the optical waveguide 26 is injected into the illumination arm 12 of the interferometer 10 by optics 28 located in the output area 27 thereof. From there, the injected light first reaches the beam splitter 11, through which it is forwarded into the reference arm 13 and reflected by a movable reference mirror 16 located at the end thereof and, after passing through the sample arm 14, illuminates an area 2 of a sample 1. Sample 1, which is, in particular, biological tissue, in particular the human skin organ, is also referred to as object within the context of the present invention.

In order to enable a most precise positioning of the OCT equipment in a straightforward way, in particular of the sample arm 14 of the interferometer 10, on the sample 1, a positioning element 3 is provided, which can be adhesively bound onto the sample 1 and which can be removed from the sample 1 after the image recording. The positioning element 3 comprises two areas having respectively a different transmittance and/or reflectance to the light emitted by the interferometer 10 and/or to the light reflected by the sample 1. Due to the different optical properties of both areas, the latter can be easily distinguished in the recorded and rendered OCT images, so that an operator can readily identify if the OCT is provided in a desired position relative to the sample or if a positional correction has to be performed, if required. Further properties of the positioning element 3 as well as details relating to the sensor head's positioning performed by the positioning element 3 will be illustrated in more detail below.

The light reflected, in particular backscattered, from the sample 1 passes through the sample arm 14 once more, is superimposed in the beam splitter 11 with the light from the reference arm 13 reflected at the reference mirror 16, and finally arrives via the detector arm 15 at a detector 30, which comprises a plurality of detector elements arranged in a, preferably flat, area and as a consequence, facilitates a spatially resolved detection of the light reflected from the sample 30 or of a corresponding interference pattern due to the superposition thereof with the light reflected at the reference mirror 16.

A CMOS camera is preferably used as the detector 30, the detector elements (so-called pixels) of which are sensitive in the infrared spectral range, in particular in a spectral range between approximately 1250 nm and 1350 nm. Preferably, the CMOS-camera has 512×640 detector elements.

As the waveguide 26 a so-called multimode fiber is preferably used, the numerical aperture and core diameter of which, for a specific wavelength of the light injected into the fiber, allow not just one fiber mode to be formed, but many different fiber modes to be excited. Preferably, the diameter of the multimode fiber used is between approximately 1 mm and 3 mm, and in particular approximately 1.5 mm.

The size of the illuminated area 2 on the sample 1 corresponds approximately to the size of the illuminated area 17 on the reference mirror 16 and is defined firstly by the optics situated at the input area of the optical waveguide 26, which in the example shown comprises the lenses 23 and 24, and secondly by the optics 28 arranged in the output area of the optical waveguide 26.

In the described OCT equipment, the resulting interference pattern is detected with the detector 30, wherein a corresponding interference signal is generated. The sampling rate of the detector 30 for sampling the interference signal must be selected such that the temporal variation of the interference pattern can be detected with sufficient accuracy. In general this requires high sampling rates, if high speeds are to be achieved for a depth scan.

A depth scan is preferably realized in the system described by causing the optical distance from the reference mirror 16 to the beam splitter 11 to be changed with a speed v during the detection of the light reflected from the sample 1 with the detector 30, by an optical path length which is substantially larger than the mean wavelength of the light injected into the interferometer 10. Preferably, the light reflected in at least 100 different depths of the sample 1 is thereby captured by the detector 30. In particular, it is preferred that the optical path is changed periodically with an amplitude which is substantially larger than the mean wavelength of the light injected into the interferometer 10. The change of the optical distance of the reference mirror 16 by the optical path or the amplitude, respectively, is preferably at least 100 times, in particular at least 1000 times, greater than the mean wavelength of the light injected into the interferometer 10. Because of the large path lengths in this distance variation, this movement of the reference mirror 16 is also referred to as macroscopic movement.

Since the individual periods of an interference pattern in general need to be sampled at multiple time points respectively, the maximum possible scanning speed in the direction of the depth of the sample 1 is dependent on the maximum possible sampling rate of the detector 30. When using fast detector arrays with high spatial resolution, i.e. a large number of detector elements per unit length, the maximum sampling rate is typically in the range of approximately 1 kHz. For a mean wavelength of the light injected into the interferometer of, for example, 1300 nm, this will result in a maximum speed for the depth scan of approximately 0.1 mm/s, if four points per period of an interference structure are sampled.

To increase the speed of the depth scan, in the present OCT equipment the temporal profile of the sensitivity of the detector 30 for the light to be detected is modulated with a frequency that is up to 40% greater than or less than the Doppler frequency f_{D}, wherein the Doppler frequency f_{D} is related to the mean wavelength λ₀ of the light injected into the interferometer 10 and the speed v of the movable reference mirror 16 as follows: f_{D}=2v/λ₀. Typical frequencies of this modulation are in the range between 1 kHz and 25 kHz. It is particularly preferred that the frequency of the modulation of the detector sensitivity is not equal to the Doppler frequency f_{D}.

The light reflected by the sample 1 and impinging on the detector 30 is superimposed with the modulated sensitivity of the detector 30, so that during the detection of the interference pattern impinging on the detector 30, instead of a high-frequency interference signal with a plurality of periods, the detector 30 generates a low-frequency beat signal which has markedly fewer periods than the high-frequency interference signal. In sampling this beating, considerably fewer sampling time points per time unit are therefore necessary, without losing any relevant information, than for sampling of the high-frequency interference signal without the modulation of the sensitivity of the detector 30. For a given maximum sampling rate of the detector 30, this means that the maximum speed for a depth scan of the system can be increased many times.

The sensitivity of the detector 30 can be modulated, e.g. directly or with a controllable electronic shutter arranged in front of the detector 30. As an alternative or in addition, properties of an optical element in front of the detector 30, such as e.g. the transmittance of a detector objective for the light reflected from the sample 1, can be modulated. Compared to systems with a constant detector sensitivity this increases the scanning speed by a factor of 4 or even 8.

The speed of the movement of the reference mirror 16 is preferably in a fixed relationship to the frequency of the modulation of the sensitivity of the detector 30 and is in particular chosen such that an integral number of sampling time points, preferably four sampling time points, fit into one period of the resulting beating signal.

The beating signals sampled in this way need to be further processed prior to being displayed, since these signals still contain the interference information. The essential information to be displayed is the amplitude and depth position of the respective interference, but not the interference structure itself. In order to do this, the beating signal must be demodulated, by determining the so-called envelope of the beating signal e.g. by Fourier or Hilpert transformation.

Since the phase of the beating signal is in general unknown and can also differ for different beating signals from different depths, a digital demodulation algorithm is used, which is independent of the phase. For sampling the interference signal with four sampling time points per period, the so-called 90° phase shift algorithms are preferably used. This allows a fast demodulation of the beating signal.

Preferably, one period of the modulation of the sensitivity of the detector 30 comprises two sub-periods, wherein during a first sub-period the detector is sensitive and during a second sub-period the detector is insensitive to the light to be detected. In general, the first and the second sub-period are equal in length. However, it can be advantageous to choose a different duration for the first and second sub-period. This is the case, for example, when the intensity of the light emitted by the light source 20, or injected into the interferometer 10, and/or of the light reflected from the sample 1, is relatively low. In these cases the first sub-period can be selected such that its duration is longer than the duration of the second sub-period. In this way, even at low light intensities, in addition to a high depth scanning speed, a high signal-to-noise ratio, and thus a high image quality, is ensured.

Alternatively to the sensitivity of the detector 30, the intensity of the light injected into the interferometer 10 can also be temporally modulated, wherein the remarks on the modulation of the detector sensitivity described above, apply accordingly with regard to the preferred embodiments and the advantageous effects.

The radiation source 21 preferably includes a spiral-shaped wire, which is surrounded by a transmissive casing, preferably made of glass. Preferably, the radiation source 21 is implemented as a halogen light bulb, in particular a tungsten halogen bulb, whereby a tungsten filament is used as wire and the inside of the casing is filled with gas, which contains a halogen, e.g. iodine or bromine. By application of an electrical voltage, the spiral wire is made to glow, which causes it to emit spatially incoherent light. The term spatially incoherent light within the context of the present invention is to be understood as light whose spatial coherence length is less than 15 μm, and in particular only a few μm, i.e. between approximately 1 μm and 5 μm.

The spatially incoherent light generated by the radiation source 21 passes through the optical filter 22, which is implemented as a band-pass filter and essentially only transmits light within a specifiable spectral bandwidth. The optical filter 22 has a bell-shaped or Gaussian spectral filter characteristic, wherein only those spectral light components of the light generated by the radiation source 21 which lie within the specified bandwidth about a mean wavelength of the bell-shaped or Gaussian spectral filter characteristic can pass through the optical filter 22.

A Gaussian spectral filter characteristic within the context of the invention is to be understood to mean that the transmittance of the optical filter 22 for light with particular wavelengths λ is proportional to exp[−[(λ−λ₀)/2·Δλ]²], where λ₀ designates the wavelength at which the optical filter 22 has its maximum transmittance, and Δλ the standard deviation, which is related to the full width at half maximum (FWHM) of the Gaussian transmittance curve as follows: FWHM≈2.35·Δλ.

A bell-shaped spectral filter characteristic is to be understood as a spectral plot of the transmittance of the optical filter 22, which can be approximated by a Gaussian function and/or only deviates from a Gaussian function to the extent that its Fourier transform has essentially a Gaussian shape with either no secondary maxima or only a small number of very low secondary maxima, the height of which is a maximum of 5% of the maximum of the Fourier transform.

The use of a radiation source 21 which a priori generates spatially incoherent light, in the detection of the light reflected by the sample 1 by the two-dimensional spatially resolving detector 30, prevents the occurrence of so-called ghost images caused by coherent crosstalk between light beams from different locations within the sample 1 under test. The additional equipment for destroying the spatial coherence, which is normally required when using spatially coherent radiation sources, can thereby be omitted.

In addition, thermal radiation sources such as e.g. incandescent or halogen lamps can therefore be used to produce incoherent light, which are much more powerful and more cost-effective than the frequently used superluminescent diodes (SLDs).

Due to the optical filtering with a Gaussian or bell-shaped filter characteristic, the light generated by the radiation source 21 is converted into temporally partially coherent light with a temporal coherence length of preferably more than approximately 6 μm. This is particularly advantageous with the described OCT equipment which is of the so-called time-domain OCT type, in which the length of a reference arm 13 in the interferometer 10 changes and the intensity of the resulting interference is continuously detected by a preferably two-dimensional detector 30 because, by filtering the light using the bandpass realized by the optical filter 22 on the one hand, a high lateral resolution of the image captured from the sample 1 is obtained, and on the other hand, due to the Gaussian or bell-shaped spectral filter characteristic of the optical filter 22, the occurrence of interfering secondary maxima in the Fourier transform of the interference pattern detected by the detector, which would cause the occurrence of further ghost images, is avoided.

Overall, the described OCT equipment allows obtaining OCT images with high resolution and image quality in an easy way.

In the example shown, the optical filter 22 is arranged between the radiation source 21 and the optics formed from the two lenses 23 and 24 on the input side. In principle, it is also possible however to provide the optical filter 22 between the two lenses 23 and 24 or between the lens 24 and the input area 25 of the optical waveguide 26. Essentially, an arrangement of the optical filter 22 is particularly advantageous if the light rays impinging on the optical filter 22 have only a small divergence, or in particular run parallel to one another, because, firstly, this reduces reflection losses at the boundary surfaces of the optical filter 22 and secondly, it reduces any beam displacement due to light refraction. In the example shown therefore, an arrangement of the optical filter 22 between the two lenses 23 and 24 of the optics is preferred.

Alternatively or in addition, it is also possible however to mount the optical filter 22 directly on the casing of the radiation source 21. This has the advantage that an additional filter component can be dispensed with.

Alternatively or in addition, it is also possible however to arrange the optical filter 22 between the output area 27 of the optical waveguide 26 and the illumination arm 12, for example in front of or between the lenses of the optics 28 located between the output area 27 of the optical waveguide 26 and the input of the illumination arm 12.

In a simple and highly reliable variant, the optical filter 22 comprises an absorption filter, in particular a so-called dyed-in-the-mass glass, and an interference filter, wherein multiple, preferably between about 30 and 70, thin layers with different refractive indices are applied to the dyed-in-the-mass glass, for example, by vapor deposition, which results in an interference filter.

For the case where the optical filter 22 is integrated into the casing of the radiation source 21, the optical filter 22 is preferably implemented by applying such interference layers to the casing. As an alternative, or in addition, it is also possible however to provide one or more of, respectively, the lenses 23, 24 or the lenses of the optics 28 with a corresponding interference filter.

### 2. Operating Modes of the OCT Equipment

The described OCT equipment can be operated in three different operating modes. The operating modes entail two real time modes, where OCT images of sample 1 are generated at a high rate of at least one image per second, preferably approximately 5 to 10 images per second, as well as one static operating mode.

In the first operating mode, real time mode 1, two-dimensional depth sections of sample 1 are generated in real time (so-called slices). This is realized by using a CMOS camera as the detector 30, which permits the adjustment of a so-called window of interest (WOI), where only a partial surface of the detector 30 is sensitive to light and converts the same to corresponding detector signals. The reduction of the sensitive camera surface is associated with a distinct increase in camera speed, so that with this setting more camera images can be generated per second than in the full-image mode.

In the real time mode 1, a WOI is preferably selected that matches the entire camera length or width (for example 640 pixels) along one direction, and has the—determined by the type of respective camera—least possible number of pixels (for example 4 pixels) in the other direction. As a result the speed of the camera is increased to such an extent that OCT images can be sampled in real time.

This is preferably achieved with the previously described modulation of the sensitivity of the detector 30 or the modulation of the intensity of the light injected into the interferometer 10, or the light emitted by the interferometer 10.

By way of example, FIG. 2 shows a detector 30 with a detector surface A1, which comprises a first plurality N1 of detector elements 31 arranged in a plane, and has a length c1 and a width b1. With the setting of a WOI as stated above, light is only detected by the detector elements 31 that are located in a partial surface A2 of the detector surface A1, and converted into corresponding detector signals. The second plurality N2 of the detector elements 31 of the partial surface A2 is smaller than the first plurality N1 of the detector elements 31 of the entire detector surface A1. The lengths c1 and c2 of, respectively, the detector surface A1 and partial surface A2 are equal in size, while the widths b1 and b2 of, respectively, the detector surface A1 and partial surface A2 differ.

In the shown example, the partial surface A2 is only 4 pixels wide, while the detector surface A1 is 512 pixels wide. The sensitive surface of the detector surface A1 is consequently reduced by a factor of 128, which significantly shortens the time duration required for the detection of the interference patterns and their conversion to corresponding detector signals.

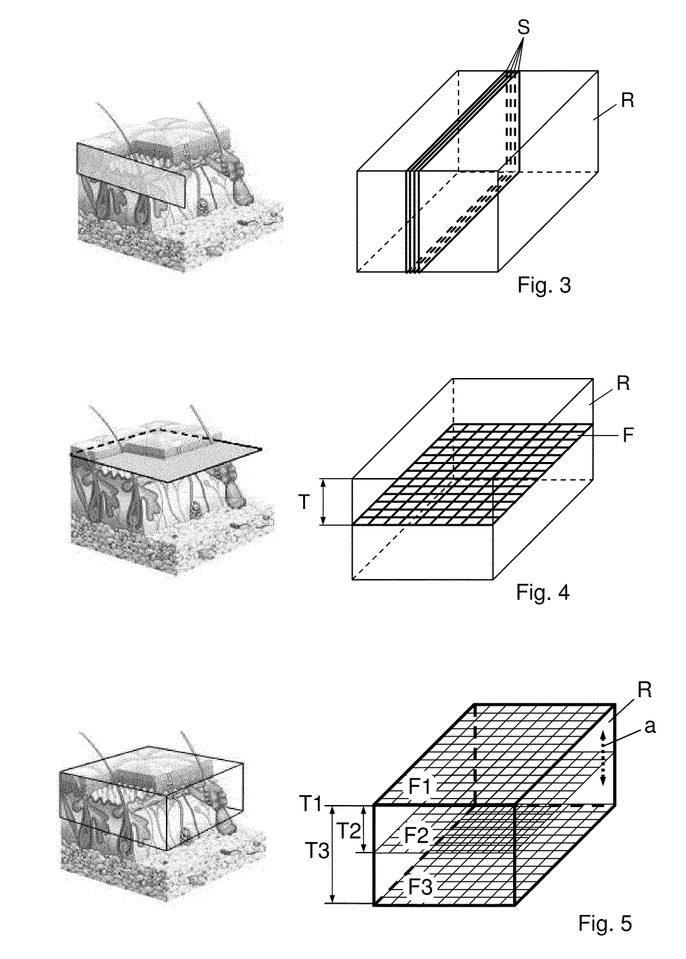

As displayed in FIG. 3, only four (corresponding to the four pixel rows of the partial surface A2) two-dimensional depth sections S (so-called slices) are obtained in this example from the observed spatial element R of sample 1, instead of a full three-dimensional tomogram. Due to the slices that are obtained in the first operating mode, this mode is also referred to as the slice mode.

For purposes of further illustration, the left part of FIG. 3 shows a model of the human skin, where as an example a plane of a two-dimensional depth section or slice sampled in operating mode 1, preferably in real time, is delineated.

In the second operating mode, the real time mode 2, two-dimensional tomograms F are generated—as displayed in FIG. 4—at a certain depth T of the observed spatial element R of sample 1, wherein the depth T can be arbitrarily selected. Hereby the entire detector surface A1 of the detector 30 is used for the detection of the light reflected by sample 1 and the conversion thereof into corresponding detector signals, wherein however only maximally five camera images in each case are considered for the calculation of a tomogram F. To that end the reference mirror 16 is moved periodically in the interferometer 10 at a certain distance to the beam splitter 11 at an amplitude of about 1 μm about this distance, while up to five camera images are sampled, which are then computed into an OCT image. In this manner tomograms F can be generated at a high repetition rate, in particular in real time. In comparison to the macroscopic movement of the reference mirror 16 described above, the movement of the reference mirror 16 in this case is microscopic.

The depth T at which the tomogram F is obtained can be arbitrarily selected by the macroscopic movement of the reference mirror 16—if applicable in combination with focus tracking, which is described in more detail further below, of the light that is focused at a certain depth T in the sample by the sample optics that are located in the sample arm 14.

On the basis of the two-dimensional cuts F obtained in the second operating mode, through the sample 1 in planes that run substantially perpendicular to the direction of the light impinging on the sample 1, the second operating mode is also referred to as en-face mode.

For purposes of further illustration, the left part of FIG. 4 shows a model of the human skin, where as an example a plane of a two-dimensional tomogram or en-face image sampled in operating mode 2, preferably in real time, is delineated.

In the third operating mode, a static mode, a complete three-dimensional data set is sampled with the aid of the macroscopic movement of the reference mirror 16 in combination with focus tracking.

At a mean wavelength of the light that is injected into the interferometer 10 in the range of, for example, 1 μm, the optical path length or amplitude of the macroscopic movement of the reference mirror 16 is at least approximately 0.1 mm, preferably at least approximately 1 mm.

In contrast to the conventional microscopic amplitude of the reference mirror movement, which is on the order of magnitude of the mean wavelength of the injected light, i.e. of up to typically 1 μm, in the described OCT equipment a macroscopic movement of the reference mirror 16 on the order of magnitude of 0.1 mm up to several millimeters takes place.

During the macroscopic linear movement of the reference mirror 16, the light reflected by sample 1 is forwarded to the two-dimensional detector 30 via the interferometer 10 and detected by said detector successively at several time points for a certain time duration, which corresponds to the integration time of the detector 30, in each case, and converted into corresponding detector signals.

In order for the light reflected from the reference mirror 16 and from the sample 1 to be able to interfere, the so-called coherence condition has to be satisfied, which states inter alia that the respectively reflected light waves must have a constant phase relation relative to one another in order to be able to interfere with one another. Due to the use of light with a very short coherence length of typically 10 μm or less, the condition of a constant phase relation is only satisfied at certain depths or depth ranges of the sample 1, which is also referred to as coherence gate.

Each position of the reference mirror 16 during the macroscopic movement corresponds thereby to a certain depth within the sample 1, or to a depth range about this certain depth for which the coherence condition is satisfied, so that the light reflected by the reference mirror 16 and by the sample 1 can interfere.

In the case of a periodic movement of the reference mirror 16, both half-periods of the periodic movement of the reference mirror 16 can each be used for the recording of detector signals.

In this manner, successive two-dimensional cuts are sampled by the detector 30 at different depths of the sample 1. This is illustrated in FIG. 5, where—representative for a plurality of two-dimensional cuts—a first, second and third two-dimensional cut F1, F2 and F3 respectively through a spatial element R is displayed. Such a two-dimensional cut “propagates” synchronously with the macroscopic movement of the reference mirror 16 in direction “a” through the observed spatial element R of the sample 1, without the same having to be moved.

Every cut F1, F2 and F3 is located at a depth T1, T2 and T3 respectively of the sample 1, at which depth the coherence condition is satisfied in each case, so that the light reflected by the reference mirror 16 and by the sample 1 can interfere. The macroscopic movement of the reference mirror 16 in combination with the successive two-dimensional detection of the light reflected by the sample 1 therefore has the effect of a three-dimensional depth scan.

The combination, as described above, of the macroscopic linear movement of the reference mirror 16 on the one hand with the detection of the light reflected by the sample 1 with a two-dimensional detector 30 on the other, facilitates a straightforwardly implementable and quick recording of a complete three-dimensional data set of the desired spatial element R1 of the sample 1.

Due to the macroscopic movement of the reference mirror 16, a three-dimensional tomogram is hereby obtained instead of just a two-dimensional image at a certain depth. In the process, the sample 1 has to be no longer moved relative to the second interferometer 20 for the recording of a three-dimensional data record. This makes the described OCT equipment compact, reliable and straightforwardly handleable, so that the same is particularly suitable for in vivo use.

The left part of FIG. 5 shows, for further illustration, a model of the human skin, where as an example a spatial element is delineated, of which in operating mode 3 a three-dimensional tomogram is sampled.

### 3. Focus Tracking

The OCT equipment described above is designed such that during a full stroke, meaning the path length or twice the amplitude, of the movement of the reference mirror 16 an interference signal of sufficiently high intensity and high sharpness is always obtained. As a result of the focus tracking, which is described in more detail hereinafter, assurance is furthermore provided that the interference signal as well as the sharpness of the detected interference pattern are maximized for all depths in the sample 1.

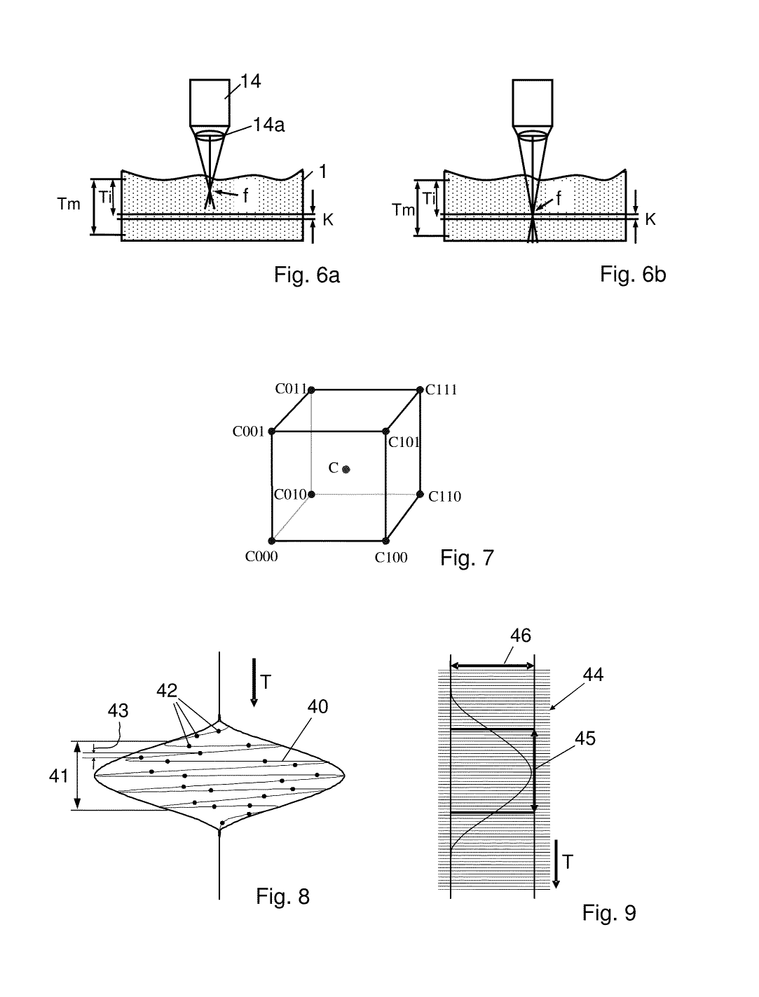

To that end, during the detection of the light that is reflected from the sample 1, the focus, meaning the focal point, of the imaging optics of the interferometer 10 that is located in the sample arm 14, is adjusted in such a manner that the location of the focus in the sample 1 and the location of that plane in the sample 1 for which in case of a reflection of light the coherence condition is satisfied and interference occurs, are essentially identical at all times during the recording of a tomogram of the spatial element R of the sample 1. This is illustrated in what follows on the basis of FIGS. 6a and 6b.

FIG. 6a shows the case where the focus f of the—here only shown simplified as a lens—sample objective 14a in the sample arm 14 is located at a depth of the sample 1 that does not coincide with the location of the coherence gate K. As a result the cut, through sample 1, that was obtained within the coherence gate K at a depth Ti is not imaged exactly in focus onto the detector 30 (see FIG. 1), so that information losses would have to be accepted while detecting the interference.

In FIG. 6b, on the other hand, the case is displayed where the focus f of the sample objective 14a is set such that it is located within the coherence gate K at a depth Ti. This tracking of the focus f of the sample objective 14a, corresponding to the depth Ti of the coherence gate K in each case, is referred to as focus tracking. In this manner, the interferometer 10 is focused during the depth scan on the respective location of the coherence gate K at different depths Ti of the sample 1, so that images with a high sharpness are obtained from any depth of sample 1.

The maximum optical scan depth Tm specifies to what depth beneath the surface of the sample 1 the coherence condition for constructive interference is satisfied, and corresponding interference patterns are obtained.

The sample objective 14a, which is displayed in FIGS. 6a and 6b in a simplified manner, preferably comprises several lenses that can be moved, individually and/or in groups, in the direction toward the sample 1 or away from the same. To that effect, a piezoelectric actuator, for example, is provided, in particular an ultrasound piezo motor, which is coupled with the sample objective 14a or the lenses, and moves the same along one or several guideways, in particular guide rods or guide grooves.

The movement of the sample objective 14a or the lenses takes place preferably synchronously with the macroscopic movement of the reference mirror 16 in the interferometer 10 (see FIG. 1). In this manner, the focus f of the sample objective 14a tracks the coherence gate G, while the latter traverses successively different depths T1, T2 and T3 of the sample 1, from which two-dimensional cuts F1, F2 and F3 (see FIG. 5) are sampled respectively with the aid of the detector 30.

The synchronization of the macroscopic movement of the reference mirror 16 and the focus tracking on the one hand, in combination with a two-dimensional detector 30 on the other, assures a particularly straightforward and quick recording of a plurality of in-focus two-dimensional image sections at different depths of the sample 1, and thereby the recording of a full three-dimensional image data set of high image quality.

Since the interferometer 10 and the optical imaging in the sample arm 14 are continuously matched to one another, the interference signals detected by the detector 30 are at a maximum for any depth in the sample 1, so that a very high signal to noise ratio results. Assurance is thereby furthermore provided that the lateral resolution is optimal for all depths in the sample 1, because the focus f of the imaging is always located within the coherence gate K. As a result, OCT images with a faithful detail rendering and a high contrast are obtained.

Advantageously, the speed v2 of the movement of the lens or the lenses of the sample objective 14a in the direction of the sample 1 is smaller than the speed v1 of the movement of the reference mirror 16. Preferably, a ratio v1/v2 of the speeds of the reference mirror 16 and the lenses is hereby selected, which is approximately equal to 2·n−1, or is up to about ±20%, preferably up to about ±10%, around this value. The location of the focus f and coherence gate G is hereby matched to one another with particularly high reliability.

As a result of the previously described selection of the ratio v1/v2 of the speeds of the reference mirror 12 and the lenses 42, assurance is provided that the coherence gate K and focus f are superimposed on one another during the depth scan over the entire depth range being observed. In the example above of a sample with an index of refraction of n=1.4, the ratio v1/v2 of the speeds is in the range of approximately (2·1.4−1)±20%, meaning between approximately 1.44 and 2.16, and is preferably approximately 2·1.4−1=1.8.

### 4. Trilinear Interpolation

The OCT images obtained with the OCT equipment and method described above can undergo an interpolation for the further improvement of the identification of diagnostic information, for example in the area of dermatology for the further improved identification of cavities or bulges in the skin that have a size of larger than approximately 10 μm.

A particularly advantageous interpolation method, in the context of OCT images, particularly real time images, obtained with the OCT equipment and method described above, is the so-called trilinear interpolation, where the initial image values of at least two two-dimensional initial images, which were sampled in planes of the object running parallel to one another, are interpolated in three-dimensional space, so that a two-dimensional final image is obtained. This is explained in detail in what follows.

The trilinear interpolation relates to a method for the multi-variate interpolation in a three-dimensional regular grid, i.e. a grid with the same grid constant in all three spatial directions. This is illustrated using the grid shown in FIG. 7 as an example. On the basis of an interpolation of the initial image values located on the eight corners C000 to C111 of a cube, an interpolation value located in the center point C of the cube is derived in each case.

The respective initial image values originate from initial images sampled in different planes of the object. The initial image values are light intensity values at different locations in the corresponding two-dimensional initial images. The initial image values, i.e. the light intensity values, with the coordinates C000, C001, C011 and C010 originate, for example, from a first real time image sampled in the operating mode 1 along a first depth section S (see FIG. 3), and the initial image values, i.e. the light intensity values, with the coordinates C100, C101, C111 and C110, originate from a second real time image sampled in the operating mode 1 along a second depth section S (see FIG. 3), spaced apart therefrom at a distance of the grid constant. The initial image values with the coordinates C000, C010, C110 and C100 originate, in an alternative example, from a first real time image sampled in the operating mode 2 in the form of a first two-dimensional tomogram F (see FIG. 4), and the initial image values with the coordinates C001, C011, C111 and C101 originate from a second real time image sampled in the operating mode 2 in the form of a second two-dimensional tomogram F (see FIG. 4), spaced apart therefrom at a distance of the grid constant.

An identical resolution in all three spatial dimensions is selected for a trilinear interpolation of the OCT images, in particular the real time images, obtained with the OCT equipment and method described above.

This cannot be achieved without loss of resolution with OCT systems known from prior art because usually only a relatively high axial (i.e. longitudinal, in the direction of the light impinging on the object) resolution can be realized, while the lateral (i.e. the transverse, perpendicular to the direction of the light impinging on the object) resolution is usually considerably lower. A selection of equal resolution in all three spatial directions would therefore only be possible by lowering the axial resolution, which as a rule however is not desirable because of the large loss of information, since small objects can in that case no longer be resolved. In addition it is not possible with OCT systems known from prior art to sample two two-dimensional images simultaneously, or at least almost simultaneously. This applies particularly to en-face images and scanning systems. A trilinear interpolation in real time is therefore almost impossible because in that case movement artifacts also become relevant.

In contrast, in the case of the OCT images obtained with the OCT equipment and method described above, a trilinear interpolation is possible in the case of the two-dimensional real time images captured in the operating modes 1 and 2 (slice or en-face), as well as also for the post-processing of the three-dimensional tomograms obtained in the static operating mode 3.

The axial (i.e. longitudinal) resolution is determined, in the case of the OCT equipment described above, primarily by the spectral bandwidth of the light source 20 and the index of refraction of the examined object 1, while the lateral (i.e. transverse) resolution is determined primarily by the optical imaging and the size of the detector elements 31 of the detector 30 (see FIGS. 1 and 2).

The OCT equipment described above is tuned in such a way that lateral and axial resolution are almost equal and very high. Preferably the resolution in all three dimensions is approximately 3 μm×3 μm×3 μm.

For the lateral resolution this is achieved in particular through the focus tracking described above, and for the axial resolution in particular through the use of a light source 20, which comprises a halogen lamp as a radiation source 21 in combination with a Gaussian filter 22.

Furthermore preferred is that the depth of field of the imaging optics, in particular the sample objective 14, of the interferometer 10 (see FIG. 1) is larger than the “grid spacing” of the initial image values, i.e. the spatial distance of the initial image values in the three dimensions. This provides assurance in every case that the initial image values are always captured with high accuracy.

Preferably the fact is furthermore taken into account that the sampling of the interference signal must be high enough so as not to violate the so-called sampling theorem. This is explained in detail hereinafter.

FIG. 8 shows a scheme for the illustration of the sampling of an interference pattern 40 in the direction of the depth T of an object, in comparison with the physical resolution 41 in the direction of depth T. With the OCT equipment and method described above, four points 42 each are preferably sampled per interference period of the interference pattern 40. An interference period in this case is the length of a half (mean) wavelength of the light injected into the interferometer (at a mean wavelength of approximately 1.3 μm this corresponds to approximately 0.65 μm). Consequently the distance 43 between two sampling points 42 is approximately 0.163 μm. The physical resolution 41 in air is however approximately 4 μm. This means that approximately 24 sequential lines in the depth direction T contain approximately the same physical information, and can therefore be combined into one line without significant loss of information. This in turn has the effect that the resulting volume image point (so-called voxel) has almost the same extent in all three dimensions, meaning it corresponds substantially to a cube. The initial image value corresponds thereby, for example, to a mean value or the median of the original initial image values.

FIG. 9 illustrates the previously described combining of original initial image values, which were sampled in the direction of the depth T of the object in several sequential lines 44, to one line of only one initial image value and one line height, i.e. a longitudinal extent 45 in the depth direction T that corresponds to the lateral extent 46 of an image point (pixel) of the line, perpendicular to the depth direction T.

In operating mode 1, where slices are sampled in real time, two neighboring lines of the detector 30 are simultaneously read out in the case of the trilinear interpolation. In the example of the detector 30 shown in FIG. 2, this means that the width b2 of the partial surface A2 of the detector 30 is selected such that said width extends only across two detector elements 31 in the direction of the width of the detector 30. The partial surface A2 in that case comprises only 2×640 detector elements 31 that are successively read out during a macroscopic movement of the reference mirror 16 (see FIG. 1), and are computed into a two-dimensional final image in the manner described above.

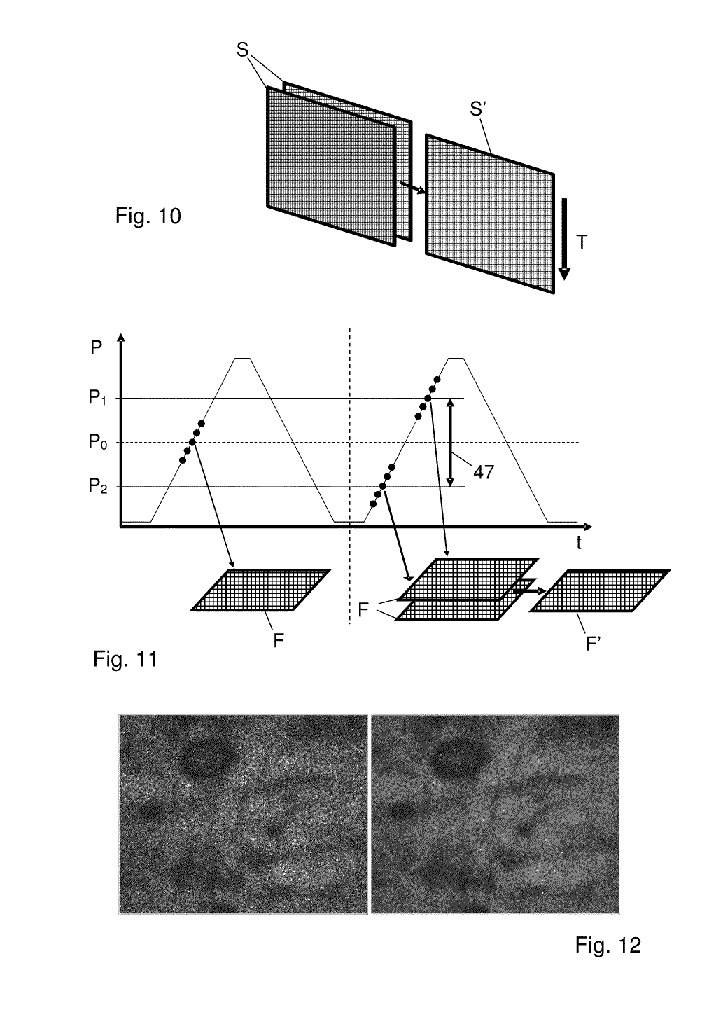

This is illustrated on the basis of FIG. 10. Two initial images S in the form of two depth sections (compare FIG. 3), which were sampled in the direction of the depth T of the object, are combined to a final image S′ using trilinear interpolation.

Since the two initial images S in the form of two depth sections are sampled simultaneously and within a very short time, it is assured that a possible relative movement between sensor head and object, in particular the human or animal skin, is of no significance during the recording of the two two-dimensional initial images S.

In the operating mode 2, in which en-face images are sampled in real time, the reference mirror 16 (see FIG. 1), which is located in a mean position, performs only a microscopic, preferably oscillating, movement from approximately +/−5 μm to +/−40 μm. In this case the position or optical imaging property of the sample objective 14 is preferably set in such a way that a focal point thereof has a mean depth position that is predefined by the macroscopic displacement of the reference mirror 16. In the case of the trilinear interpolation of the en-face images sampled in real time—in contrast to operation without trilinear interpolation—two initial images in the form of two en-face images are captured each at two different positions of the reference mirror 16, and computed into a two-dimensional final image in the form of an en-face image.

This is illustrated on the basis of the diagram shown in FIG. 11, which shows the progression of the position P of the reference mirror 16 over time t.

In the left part of the diagram of FIG. 11, the case without trilinear interpolation is displayed. In the operating mode 2 a two-dimensional initial image F is hereby obtained in the form of a tomogram from a certain depth in the object, by measuring at five positions P of the reference mirror 16, which positions are located symmetrically about a mean position P₀.

In the right part of the diagram of FIG. 11, the application of the trilinear interpolation is illustrated. Two two-dimensional initial images F are obtained by measuring at five positions P of the reference mirror 16 in each case. The five positions P are located each symmetrically about the positions P₁ and P₂, which preferably are themselves located symmetrically about the mean position P₀ of the reference mirror 16. The distance 47 between the positions P₁ and P₂ of the reference mirror 16 is in this case determined by the axial and/or lateral pixel size 45 and 46 respectively (see FIG. 9). With the preferred symmetric location of the positions P₁ and P₂ the corresponding tomograms F each are located in the object above and below the mean depth location by half a pixel size. The initial images F sampled in this manner then undergo a trilinear interpolation, during which the final image F′ is obtained.

Preferably, the depth of field of the optical imaging in the interferometer 10 (see FIG. 1) is selected such that the same is larger than half the voxel size. With a preferred voxel size of 3 μm, the depth of field must therefore be larger than 1.5 μm.

Since the described recording of the two initial images in the operating mode 2 takes place immediately one after the other, typically temporally separated by about 0.014 seconds, the effect on the obtained final image of a possible relative movement between sensor head and object, in particular the skin, between the recording of the two original initial images is almost completely ruled out or negligibly small.

During the recording of the images, the sensor head is preferably in direct contact with the surface of the object to be examined, in particular the skin, which significantly reduces the probability of a relative movement. This is a particular advantage with recordings of images of the human or animal skin, since the same is generally elastic and adheres to the tip of the sensor head, particularly during the application of a gel, so that slight lateral movements or the slight tipping of the sensor head most often do not lead to a relative movement between skin and sensor head.

In the operating mode 3, in which static three-dimensional tomograms are sampled, a beat—as described above in detail—is generated between the detector sensitivity modulation on the one hand, and the interference signal to be captured on the other. As a result, the distance between the individual sampling points in the depth direction is larger than in the operating mode 1, so that correspondingly fewer sample points, preferably between 6 and 10, in particular 8, are combined to maintain a cube-shaped three-dimensional image element (voxel).

FIG. 12 shows an example of an initial image (left) in comparison with a corresponding final image (right) that was obtained by the described interpolation. The final image is less noisy in contrast to the initial image, and appears therefore “softer” or “smoother”. During comparisons in the interpretation of the images for diagnosis purposes, it has turned out, in particular in the field of dermatology, that the relevant diagnostic information in each case can be obtained faster and more reliably from the final images obtained through trilinear interpolation. This applies in particular to cavities or inhomogeneities with a size of typically more than 10 μm.

The explanations provided above regarding the trilinear interpolation apply correspondingly also to a tricubic interpolation, where the initial values are not interpolated using a linear function, but instead using a cubic function.

### 5. System for Optical Coherence Tomography

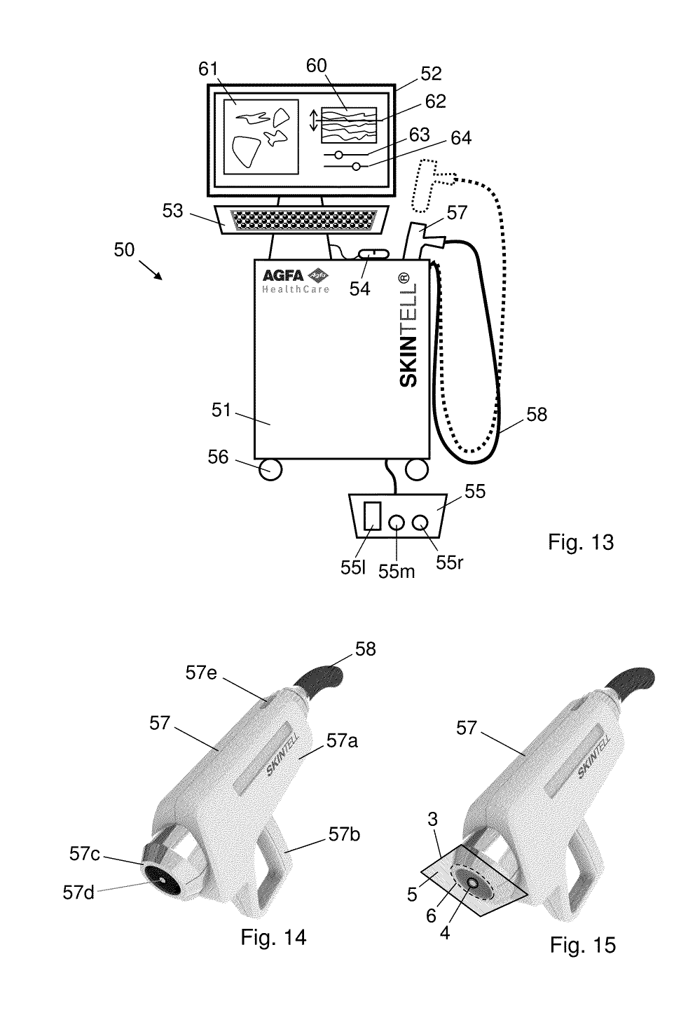

FIG. 13 shows a further example of a system 50 for optical coherence tomography. The system 50 comprises a housing 51, entry devices in the form of a key pad 53, a computer mouse 54 as well as a foot switch device 55 that has a left, center and right foot switch 55l, 55m and 55r respectively. The housing 51 in the displayed example is designed to be mobile by being provided with rollers 56.

Furthermore a sensor head 57 is provided, which is connected to the housing 51 via a cable 58 or a cable hose or—pipe. The sensor head 57, in its idle position, is plugged into a sensor head holder provided on or in the housing 51, from which said sensor head can be removed during the recording of OCT images, which in the figure is indicated by the sensor head 57, represented by a dashed line, and the cable 58, represented by a dashed line.

The system comprises a display device 52 in the form of a flat panel monitor that can display OCT images 60 and 61, which were captured by placing the sensor head 57 on an object, in particular the skin of a patient. In the example shown in the figure, the first OCT image 60 concerns a depth section running substantially perpendicular to the surface of the object being examined, which depth section was sampled in the operating mode 1 described above, and the second OCT image 61 concerns a two-dimensional tomogram that runs substantially parallel to the surface of the object being examined, and that was sampled in the operating mode 2 described above.

In the area of the first OCT image 60, a straight line 62 is displayed on the display device 52, which straight line can be moved upward or downward in the direction of the indicated double arrow, for example by selecting a corresponding position of the straight line 62 relative to the first OCT image 60 with the aid of the entry devices 53, 54 and 55. The system 50 is configured in such a way that, corresponding to the selected location of the straight line 62 in the displayed first OCT image 60, a plane in the object being examined, running perpendicular to the displayed first OCT image 60, is determined automatically and a two-dimensional tomogram is sampled there, which is then displayed as the second OCT image 61.

The first OCT image 60 is preferably a so-called slice, while the second OCT image 61 preferably represents a so-called en-face image, which has been sampled in a plane corresponding to the straight line 62 in the first OCT image 60.

A depth selection display 63 in the form of a switch symbol, which is movable along a straight line, is furthermore displayed on the monitor of the display device 52, which switch symbol shows the depth that was selected through a selection of the location of the straight line 62 relative to the first displayed OCT image 60. Alternatively or in addition, the depth can also be indicated in the form of numerical values.

One or several additional selection displays can furthermore be provided in the display device 52. In the displayed example, a selection screen 64 is provided that shows one or several properties of the object to be examined. These properties are preferably selected and entered by an operator prior to the recording of corresponding OCT images. In the case of dermatological applications, this concerns, for example, a parameter for the characterization of the moisture of the skin of the respective patient. In the corresponding selection screen 64, a corresponding switch symbol can then be moved continuously or in specified steps along a straight line between the positions “dry skin” on the left and “moist skin” on the right.

The interferometer 10 displayed in FIG. 1, including the optics 28 and the detector 30, is integrated in the sensor head 57. The light source 20, including the optics in the form of the two lenses 23 and 24 on the input side, is preferably integrated into the housing 51 of the system 50. The optical waveguide 26, which couples the light source 20 on the one hand and the interferometer 10 on the other with one another, is guided within the cable 58 from the housing 51 to the sensor head 57 in this case. In cable 58 electrical lines are furthermore guided that on the one hand serve the purpose of supplying power and controlling the sensor head 57, and on the other conduct the detector signals, which are generated during the capture of OCT images, of the detector 30 from the same into the housing 51, where they are supplied to a processing device (not displayed).

The sensor head 57, which in FIG. 13 is shown only heavily schematized, is displayed in detail in FIG. 14. A grip 57b is provided in the lower area of a sensor head housing 57a of the sensor head 57, which grip can be used by an operator to remove the sensor head 57 from the sensor head holder on or in the housing 51, or to plug said sensor head again into the sensor head holder, and to place said sensor head onto the object during the recording of OCT images and, if applicable, to guide said sensor head along said object. In this context, the sensor head 57, with a contact surface 57c that is located on the front end of the sensor head housing 57a, is brought into contact with the object to be examined, in particular the skin of a patient.

In the center of the contact surface 57c, a window 57d is provided, through which light from the sample arm 14 of the interferometer 10 (see FIG. 1) located in the sensor head 57 can pass, and can thereby irradiate the object to be examined. The light reflected and/or backscattered at different depths of the object reenters the sample arm 14 of the interferometer 10 through the window 57d and can there be captured and analyzed in the form of interference phenomena, as was already illustrated in detail above.

A status display device 57e, preferably in the form of an indicator light, is furthermore provided on the sensor head housing 57a, by which for example the readiness of the system 50 and/or the sensor head 57 for the capturing of OCT images is shown.

The cable 58, which can also be designed as a cable conduit or hose, is connected to the sensor head 57 in the area of the rear end of the sensor head housing 57a.

With the system 50 for optical coherence tomography described above, three- and two-dimensional cross section images of an object, in particular the human skin, can be sampled, where penetration depths into the human skin of up to approximately 1 mm can be reached, and the size of the surface of the skin area examined has typical dimensions of approximately 1.8×1.5 mm. Due to the infrared radiation that is used in the described system 50, with a preferred mean wavelength of approximately 1.3 μm, radiation exposure of the patient, such as for example during the use of x-rays, can be ruled out. The OCT images captured with the described system 50 furthermore have high resolution and permit a display of individual object structures on a scale up to 3 μm. Not least, the OCT images captured with the system 50 can be used for measuring the absolute geometric extent of the different structures, i.e. their size.

The system 50 comprises—even if not explicitly shown—a control device for the inventive control of the system 50, in particular the optical coherence tomography equipment, or the execution of the sequences described previously and hereinafter. The system furthermore comprises a processing device for the processing of different data, including the interpolation of initial image values described above. The control device and/or the processing device are preferably integrated into housing 51 of the system 50.

### 6. Positioning Element for Positioning the Sensor Head

As already illustrated in the context of FIG. 1, the positioning of the interferometer 10 which is integrated in the sensor head 57 relative to the object to be examined is supported by providing a positioning element 3 at the object. The sensor head 57 is then placed on the positioning element 3 and brought into a desired position.

This is shown in FIG. 15 by a positioning element 3 represented semi-transmissively for the sake of clarity. The sensor head 57 lies with its contact surface 57c (see FIG. 14) on the positioning element 3 and in the example shown it is placed in such a way that the window 57d (see FIG. 14) of the sensor head 57 lies substantially above a first area 4 of the positioning element 3. The first area 4 is substantially transmissive to the light leaving the window 57d as well as to the light reflected by the object (not shown) and again passing through the window 57d and is preferably designed in the form of an aperture in the positioning element 3.

In order to support a first, temporary arrangement of the sensor head 57 on the positioning element 3, the latter is provided with a circular marking 6 having a diameter which substantially corresponds to the outer diameter of the circular contact surface 57c of the sensor head 57. In order to achieve a good temporary placement of the sensor head 57 on the positioning element 3, the operator places the sensor head 57 on the positioning element 3 in such a way that the outer edge of the contact surface 57c of the sensor head 57 runs along the circular marking 6.

The optical properties of the second area 5 of the positioning element 3 which is surrounding the first area 4 differ from the optical properties of the first area 4 and is preferably substantially opaque to the light leaving the sensor head 57 as well as to the light reflected by the object. As an alternative or in addition, the second area 5 may have structures which are different from the structures which one would expect to see being reproduced in the OCT images of the object. These structures may be, for example, one or more partial areas, of which the transmittance and/or reflectance to the light has a characteristic, for example periodical, plot which allows identifying the second area 5, in particular one or more of the partial areas, in the OCT images and clearly distinguishing it from OCT image areas that correspond to the object.

Due to mutually distinctive optical properties of both areas 4 and 5, an operator can readily determine in the acquired and displayed OCT images if the sensor head 57 has been placed on the positioning element 3 in such a way that window 57d of the sensor head 57 does not position itself precisely above the transmissive first area 4. Depending on whether the second area 5 absorbs or reflects the light, the area in the OCT images which corresponds to the second area 5 of the positioning element 3 will appear as uniformly dark or light area. Using these images, the operator can then decide to what extent the position of the sensor head 57 relative to the current position has to be modified in order to position the window 57d as central as possible to the first area and to ensure in this way that, on the one hand, OCT images are recorded precisely from the area to be examined of the object and, on the other hand, that the respective rendered area of the object has an optimal size.

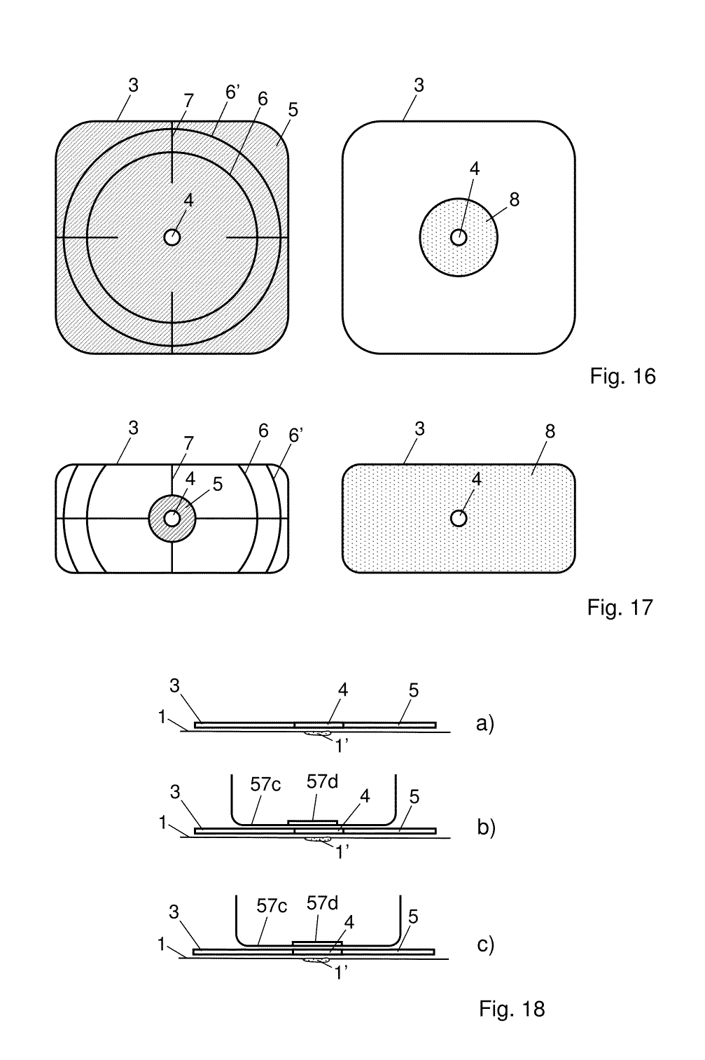

FIG. 16 shows a first example of a positioning element 3 in top view on the side facing the sensor head 57 (left) and in top view on the side facing the object (right).

The positioning element 3 is composed of a flexible support, for example made from paper and/or plastic and/or textile material, having a substantially square basic form with rounded corners and being provided with an aperture, which forms the first area 4 of the positioning element 3. The form and size of the aperture substantially correspond to the form and size of the window 57d of the sensor head 57. In the example shown, the aperture therefore has a substantially circular form.

The remaining part of the support forms the second area 5 of the positioning element 3 and is provided with a reflective layer on the side facing the sensor head 57, which reflects light leaving the sensor head 57 and preferably has a reflectance of approximately 100%. The reflective layer may preferably comprise one or more metals, such as for example aluminum, and be formed, for example, by adhesively binding, printing or vapor depositing a reflective material on the support. As an alternative or in addition, it also possible to design the support itself as a reflective support, for example in the form of a thin and/or flexible metal foil.

Concentrically to the first area 4, a first and second circular marking 6 and 6′ are provided, which support the arrangement of the sensor head 57 on the positioning element 3. The statements made in connection with FIG. 15 apply correspondingly to the first circular marking 6. The second circular marking 6′ allows the human eye to readily perceive even a minor eccentric arrangement of the contact surface 57c, which allows for an additional control of the temporary arrangement of the sensor head 57 on the positioning element 3.

Additionally to the circular markings 6 and 6′, straight lines 7 are provided as markings, which are preferably provided in the form of a crosshair around the first area 4 and which offer an additional support to the arrangement of the sensor head 3 on the positioning element 3. The markings 6, 6′ and 7 can, for example, be formed by printing, engraving or embossing them on the second area 5.

The underside of the support, as shown in FIG. 16 (right), of the positioning element 3 comprises in a circular area surrounding the first area 4 an adhering area 8, which allows to releasably attach the positioning element 3 to the object, in particular to the human skin organ. The adhering area is preferably formed by coating the underside of the support with a pressure sensitive adhesive or by applying a double-sided adhesive tape onto it. Preferably, the adhering area, in particular the layer made of a pressure sensitive adhesive, is provided with an additional protective layer (not shown), which is removed only right before using the positioning element 3. A preferred protective layer is, for example, waxed or siliconized protective paper.

FIG. 17 shows a further example of a positioning element 3 in top view on the side facing the sensor head 57 (left) and in top view on the side facing the object (right). In contrast to the first example shown in FIG. 16, the side facing the sensor head 57 of the support is provided with a reflective layer only in an area which is circularly surrounding the first area 4 and which forms, in this example, the second area 5 of the positioning element 6. Furthermore, in this example, the entire back side of the support (FIG. 17 right) is provided with an adhering area. Apart from that, the statements made in connection with the first example shown in FIG. 16 apply correspondingly to the example shown in FIG. 17.

The inventive method is explained hereinafter in more detail with reference to FIG. 18, which shows three cross sections through object 1, positioning element 3 and sensor head 57.

Part a) of FIG. 18 shows the positioning element 3, which is placed on the object 1, in this case the human skin, in particular adhesively bound, in such a way that the first area 4 lies above a region of interest 1′ to be examined in more detail of the object 1, for example a skin lesion. For the sake of clarity, the positioning element 3 and the object 1 are shown spaced apart in the representation selected here, although the positioning element 3 is adjacent to the object 1.

Part b) of FIG. 18 shows the sensor head resting on the positioning element 3 with the contact surface 57c, said sensor head having been placed temporarily on the positioning element 3 by the operator, in particular with the aid of the markings 6, 6′ and 7 (see FIGS. 15 to 17), so that the window 57d of the sensor head positions itself in the region of the first area 4 of the positioning element 3. Preferably, a medium (so-called Index Matching Gel), which allows adapting the optical refractive indices onto another, is applied between, on the one hand, contact surface 57c and window 57d of the sensor head and, on the other hand, positioning element 3 and object 1, in order to minimize light losses due to reflections at boundaries.

In order to obtain an even more precise positioning of the window 57d of the sensor head opposite to the object 1, in particular opposite to the area 1′ to be examined, wherein the window 57d is located precisely above the first area 4, OCT images are used according to the present invention, which allow the operator to perceive if the window 57d is not provided precisely above the first area 4.

In the example represented in part b) of FIG. 18, the window 57d opposite to the first area 4 is shifted slightly to the left toward the second area 5, so that the area protruding into the image area of the second area 5 will be distinguishable in the corresponding OCT images as a result of its optical properties being different from those of the first area 4. In particular in the case of the OCT images being recorded and rendered in real time, the operator can, by gradually displacing the sensor head to the right, with simultaneous observation of the respective obtained OCT images, finally arrange the sensor head in such a way, that it is located—as represented in part c) of FIG. 18—precisely above the first area 4 of the positioning element 3 and therefore ensure that it is optimally positioned relative to the area to be examined 1′ of the object 1.

By way of example, some of the OCT images recorded and rendered in the described positioning process are hereinafter illustrated in more detail.

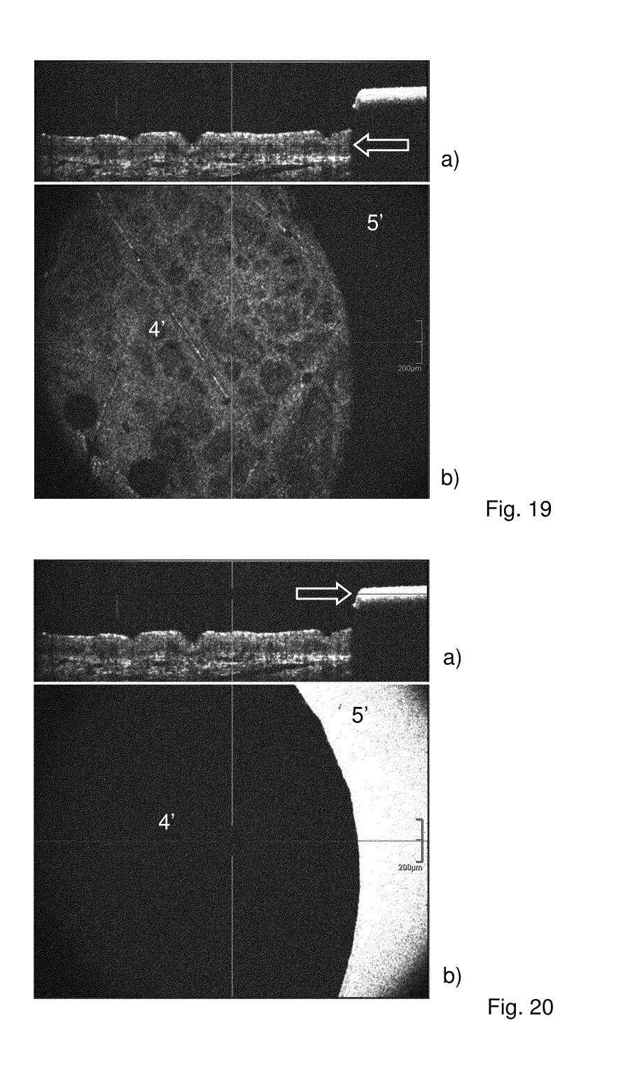

FIGS. 19 and 20 show OCT images which have been obtained using a positioning element 3 whose second area 5 absorbs most of the light reflected by, respectively, the sensor head and the object 1 without substantially reflecting it.

Part a) of the Figures is in each case a two-dimensional depth section recorded in the first operating mode (so-called slice, see FIG. 3) by the positioning element (upper part) and the object (lower part). Part b) of the Figures is in each case a two-dimensional tomogram recorded in the second operating mode at a predetermined depth in, respectively, the object and the positioning element (so-called en-face image, see FIG. 4). The arrows used in the respective slice indicate the depth at which the corresponding en-face image has been recorded.

As can be seen on FIGS. 19 and 20, in the en-face images obtained at different depths the second image area 5′ which corresponds to the second area 5 of the positioning element 3 is in each case clearly distinguishable from the first image area 4′, which corresponds to the first area 4 of the positioning element 3. In FIG. 19, the first image area 4′ shows structures at a specific depth of the object, while the second image area 5′ is represented uniformly black as a result of the second area 5 being opaque to light. In FIG. 20, the first image area 4′ is represented uniformly black, since at this depth air and Index-Matching-Gel are present in the first area 4, which induce no relevant light scattering. Due to—albeit minor—light reflections in the adjacent second area 5, the second image area 5′ in the en-face image is comparatively light.

As already described extensively above, an operator can use these OCT images, which are preferably recorded in real time, in a straightforward and comfortable way to displace the sensor head relative to the positioning element 6 and thereby arrange it in such a way that the first image area 4′ acquired from the object is optimal, while the second image area 5′ obtained from the second area 5 is minimized or is completely eliminated from the OCT images.

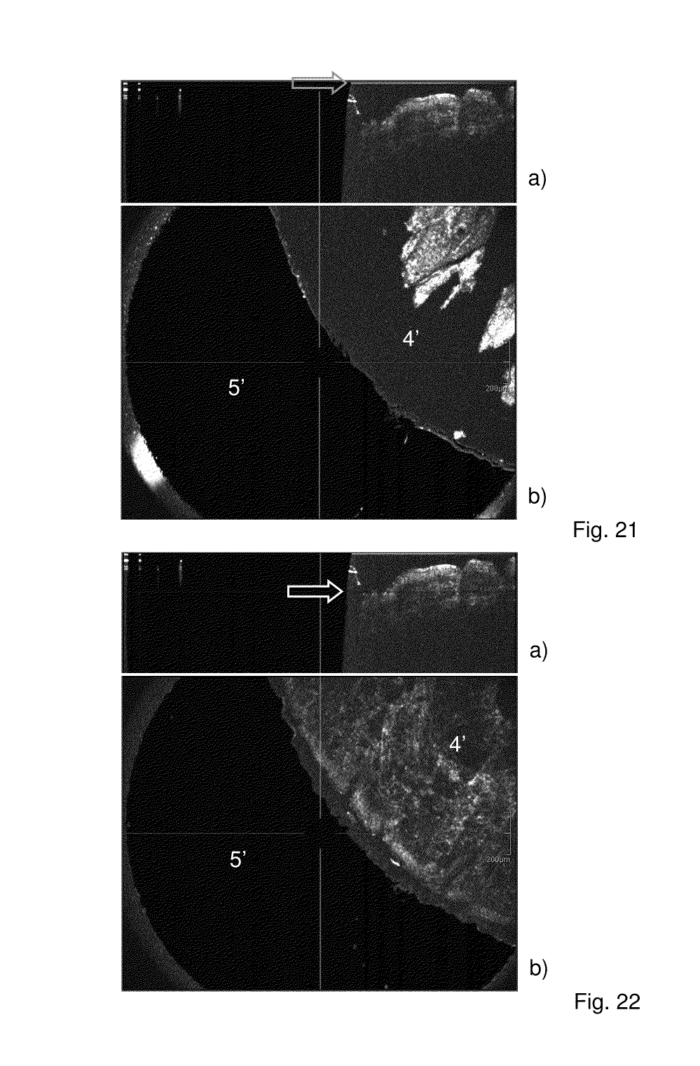

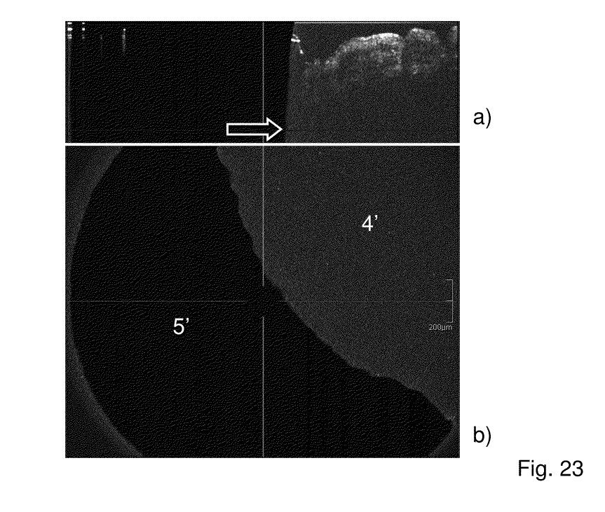

FIGS. 21 to 23 show OCT images obtained by a positioning element 3, the second area 5 of which reflects most of the light emitted by, respectively, the sensor head and the object 1. The above statements relating to the FIGS. 19 and 20 apply correspondingly to the figure parts a) and b).

During the recording of the OCT images shown in this example, the detector of the OCT system was operated and/or controlled in such a way, that it is in saturation mode during the detection of the light reflected by the second area 5 of the positioning element 3, i.e. all of the detector signals emitted by the detector have a specific or a specifiable maximum value. During the demodulation, which consists in deriving the OCT images from the detector signals of the detected interference images, only changes in the detector signal are detected. However, since the detector operating in saturation mode does not show any change of the detector signal, the demodulation results in the respective OCT images having a fully black and thus noise-free second image 5′, which corresponds to the second area 5 of the positioning element 3. As a result, a high contrast between the first image area 4′ and the second image area 5′ can be seen at all depths in the shown en-face images.

Further aspects, alternatives and advantages of the positioning element are illustrated hereinafter in more detail.

Preferably, the positioning element has a small hole in the middle, which can have a round or square shape. The diameter and edge length, respectively, of the hole is preferably adapted to the image area diagonal (IAD) of the OCT system, said diameter being between approximately 100% and 200% of the IAD in case of a round hole and the edge length being between 75% and 170% of the IAD in case of a square hole.

Preferably, the material of the positioning element is chosen and textured in such a way that it creates a visible contrast at as many depths as possible. This can be achieved, for example, by shadowing, whereby the material is not transmissive to the light used, in particular at a wavelength of approximately 1.3 μm. Another option consists in ensuring a strong reflection, whereby the material reflects at a thickness of approximately 1.3 μm. In this case, the reflection is preferably so strong that the detector switches into saturation mode. After a demodulation (FSA) of the detector signals, this results in a fully black and noise-free image which can be observed in the area of the highly reflecting material.

The transition area between the hole and the positioning element is visible in both the slice image and the en-face image. In particular if reflective materials are used, this even applies to all depths at which OCT images have been recorded.

The adhering area on the back side of the positioning element may be—notably, as the case may be—smaller than the total surface of the positioning element and should adhere only slightly to the skin. This allows peeling off the positioning element in a straightforward and painless way.

The outer diameter of the positioning element may be larger than the tip of the sensor head and may comprise, for example, a crosshair and centering circles in order to allow for an easy identification of the center.

The outer diameter of the positioning element may be—notably, as the case may be—smaller than the tip, in particular the support area, of the sensor head.

The user positions the hole of the positioning element precisely at the position on the skin that is to be examined with the OCT system. The sensor head is then provided above or on the positioning element in such a way that the inner circle of the concentric centering circles is perfectly covered. The outer one of the circles serves as an additional positioning control circle, since the human eye readily perceives inaccuracies in concentricity, and thus allows the user to easily correct the positioning of the sensor head.

The crosshair, which is preferably printed on the positioning element, enables an additional position control of the sensor head.

As the positioning element creates a visible contrast in the OCT images, the user can reliably and comfortably identify the skin position searched for, without inaccuracies that could occur due to tolerances.

The use of the positioning element is virtually self-explaining and in general does not require any extensive training of its user. Thanks to the described principle, this solution allows for a reliable positioning of the sensor head on the ROI (Region of Interest), thus providing assurance that the acquired image originates from the corresponding skin region. The system is a priori “free of tolerances”, as an OCT image is generated only in the area of the opening.

The reflective material of the positioning element furthermore provides assurance that the covered skin regions are nested in the OCT image, which results in a good contrast between the area on the positioning element and the skin at all depths.

Furthermore, the positioning element has a simple design and can be manufactured at a competitive price. The positioning element can be manufactured using biocompatible materials, which prevent skin irritations. The adhering area can be selected so that the positioning element can be peeled off easily, without injuring the skin. The use of a small positioning element allows for marking also skin regions which are difficult to access.

### 7. Additional Inventive Aspects of the System and Method

The OCT system and method previously described in more detail has individual features or feature combinations that make the system and method more straightforward, quicker and more reliable with regard to handling and image acquisition, without all of the features listed in the independent claims being hereby imperatively required. These features or feature combinations are likewise considered an invention.

In particular, a system for optical coherence tomography is considered an invention with at least one interferometer for the emission of light for the irradiation of an object, and a detector for the detection of light that is reflected and/or backscattered from the object, wherein the system is characterized by one or a plurality of features, which were previously described in more detail, in particular in the sections 1 to 6 and/or in connection with the figures. The method corresponding to this system is likewise considered an invention.

1-16. (canceled)

17. A system for performing optical coherence tomography, the system comprising:
an interferometer including a sensor head configured to emit electromagnetic radiation toward an object to be examined and to feed back electromagnetic radiation reflected by the object to the interferometer;
a positioning element configured to position the sensor head relative to the object, the positioning element including a support on which the sensor head is placed, a first area that is substantially transmissive to the electromagnetic radiation emitted by the interferometer and reflected by the object, and a second area having a transmittance to the electromagnetic radiation emitted by the interferometer and/or reflected by the object that is different from a transmittance of the first area;
an image generator configured to generate one or more images on a basis of the electromagnetic radiation reflected by the object and/or by the positioning element;
a display device configured to display the one or more images; and
a controller configured or programmed to control generation and display of the one or more images in such a manner that the sensor head is brought into a desired position on the positioning element on a basis of the generated and displayed one or more images.

18. The system according to claim 17, wherein the second area is substantially opaque to the electromagnetic radiation emitted by the interferometer and/or reflected by the object.

19. The system according to claim 17, wherein the second area includes a structure including optical properties that differ from optical properties of structures of the object.

20. The system according to claim 17, wherein the support is flexible and configured to adapt itself to contours of the object.

21. The system according to claim 17, wherein the support is configured to be brought into releasable contact with the object.

22. The system according to claim 17, wherein the first area of the support includes an aperture in the support.

23. The system according to claim 17, wherein a form and/or size of the first area of the support corresponds to a form and/or size of a passage area of the sensor head, and the electromagnetic radiation emitted by the interferometer and reflected by the object passes through the passage area.

24. The system according to claim 17, wherein the positioning element includes one or more markings to support positioning of the sensor head relative to the positioning element.

25. The system according to claim 17, wherein the transmittance of the second area of the support is less than 10⁻⁴.

26. The system according to claim 17, wherein the second area of the support includes a reflecting layer that reflects the electromagnetic radiation emitted by the interferometer.

27. The system according to claim 26, wherein the reflecting layer of the second area of the support has a reflectivity to the electromagnetic radiation emitted by the interferometer of at least 30%.

28. The system according to claim 17, wherein the interferometer is configured to obtain one or more images from different depths of the object and the controller is configured or programmed to generate and display the one or more images on a basis of the electromagnetic radiation reflected at the different depths of the object such that a transition in the one or more images between the object and the positioning element is recognized.

29. The system according to claim 17, further comprising:
a detector configured to detect the electromagnetic radiation reflected by the object and/or by the positioning element and fed back into the interferometer; wherein
the controller is configured or programmed to control the detector such that, during detection of the electromagnetic radiation reflected by the positioning element and fed back into the interferometer, the detector is in a saturation mode of operation.

30. The system according to claim 17, wherein the image generator is configured to operate at a rate of more than one image per second, and/or the display device is configured to operate at a rate of more than one image per second.

31. A positioning element for use in a system for optical coherence tomography, the system including an interferometer and a sensor head configured to emit electromagnetic radiation toward an object to be examined and to feed back electromagnetic radiation reflected by the object to the interferometer, wherein the positioning element comprises:
a support configured to position the sensor head relative to the object, the support including a first area that is substantially transmissive to the electromagnetic radiation emitted by the interferometer and reflected by the object, and a second area having a transmittance to the electromagnetic radiation emitted by the interferometer and/or reflected by the object that is different from a transmittance of the first area.

32. A method for performing optical coherence tomography, the method comprising the steps of:
emitting electromagnetic radiation from an interferometer toward an object to be examined via a sensor head, and feeding back electromagnetic radiation reflected from the object to the interferometer via the sensor head;
positioning the sensor head relative to the object and placing the sensor head on a support, the support including a first area that is substantially transmissive to the electromagnetic radiation emitted by the interferometer and reflected by the object, and a second area having a transmittance to the electromagnetic radiation emitted by the interferometer and/or reflected by the object that is different from a transmittance of the first area;
generating one or more images and displaying the one or more images on a basis of the electromagnetic radiation reflected by the object and/or by a positioning element; and
bringing the sensor head into a desired position on the positioning element on a basis of the one or more generated and displayed images.
